(19) United States
(12) Patent Application Publication
(10) Pub. No.: US 2003/0154221 A1
(43) Pub. Date: Aug. 14, 2003

(54) System and method for accessing file system entities

(75) Inventors: Germano Caronni, Palo Alto, CA (US); Sandeep Kumar, Santa Clara, CA (US)

Correspondence Address: Finnegan, Henderson, Farabow,, Garrett & Dunner, L.L.P., 1300 I Street, N.W., Washington, DC, 20005-3315, US

(73) Assignee: Sun Microsystems, Inc.

(21) Appl. No.: 10/073,131

(22) Filed: Feb. 13, 2002

(51) Int. Cl. G06F 17/30

(52) U.S. Cl. 707/205

(57) ABSTRACT

Methods and systems for accessing file system entities. A lookup routine receives a request from a node to access a file system entity. After determining that a file system view table does not have a first entry that corresponds to the file system entity, the lookup routine searches the file system view table for an alternate entry. The alternate entry comprises an entity name of the requested entity, extended by an uncommon string of characters including an expandable sequence. The lookup routine then expands the expandable sequence of the alternate entry by a value corresponding to the node, and retrieves information from the file system view table corresponding to the expanded alternate entry.

### FIELD OF THE INVENTION

The present invention relates generally to data processing systems and, more particularly, to a system and method for accessing file system entities.

### DESCRIPTION OF RELATED ART

Many file systems present a global view of data accessible to all processes running on a machine with access to those file systems. There are situations, however, where it is advantageous to provide different processes with different views of a file system. Machines with multiple network interfaces, machines with multiple disparate network views, and machines running multi-level trusted systems where different users get access to different parts of the system, are all such situations.

Conventional systems may implement differing file system views, for example, by utilizing file and folder permissions or access control lists. For example, in a UNIX operating system, the chroot ( ) system call limits a file system view to a certain subset of files. Other systems enable a user to move parts of a globally valid directory (e.g., folder) tree for a private view. Yet other systems enable a user to create a new directory tree with a private view of processes by mounting file systems over a network.

Conventional systems, however, do not have mechanisms in place that allow processes to enforce different views (e.g., permit different processes access to different content, files, or folders) dependent on the context that a process is in.

### SUMMARY OF THE INVENTION

Methods and systems consistent with the principles of the invention access file system entities. A lookup routine receives a request from a node to access a file system entity having an entity name. The lookup routine searches for an alternate entry that comprises the entity name of the requested entity extended by an expandable sequence. The lookup routine then expands the expandable sequence by a value corresponding to the node, and retrieves information corresponding to the expanded sequence.

Other methods and systems consistent with the principles of the invention access file system entities. A lookup routine receives a request from a node to access a file system entity having an entity name. The lookup routine searches for an alternate entry that comprises the entity name of the requested entity extended by an uncommon string of characters including an expandable sequence. The lookup routine then expands the expandable sequence of the alternate entry by a value corresponding to the node, and retrieves information from the file system view table corresponding to the expanded alternate entry.

Other methods and systems consistent with the principles of the invention also access file system entities. A lookup routine receives a request from a node to access a file system entity having an entity name. After determining that a file system view table does not have a first entry that corresponds to the file system entity, the lookup routine searches the file system view table for an alternate entry. The alternate entry comprises the entity name of the requested entity extended by an uncommon string of characters including an expandable sequence. The lookup routine then expands the expandable sequence of the alternate entry by a value corresponding to the node, and retrieves information from the file system view table corresponding to the expanded alternate entry.

Other methods and systems consistent with the principles of the invention also access file system entities. A secondary storage comprises a plurality of file system entities, each of the file system entities having an entity name. An operating system in a memory includes a file system view table with a plurality of entries, and a lookup routine. The lookup routine receives a request from a node to access a file system entity. After determining that the file system view table does not have a first entry that corresponds to the file system entity, the lookup routine searches the file system view table for an alternate entry. The alternate entry comprises the entity name of the requested entity extended by an uncommon string of characters including an expandable sequence. The lookup routine then expands the expandable sequence of the alternate entry by a value corresponding to the node, and retrieves information from the file system view table corresponding to the expanded alternate entry.

Other methods and systems consistent with the principles of the invention also access file system entities. A data structure for use by an operating system in accessing file system entities comprises a first entry and a second entry. The first entry comprises an entity name extended by an uncommon string of characters including an expandable sequence. The second entry comprises the entity name extended by an uncommon string of characters including a value representative of a context of a node.

Other methods and systems consistent with the principles of the invention also access file system entities. A node sends, to a lookup routine, a request for access to a file system entity having an entity name. The lookup routine searches for an alternate entry that comprises the entity name of the requested entity extended by an uncommon string of characters including an expandable sequence. The lookup routine then expands the expandable sequence of the alternate entry by a value corresponding to the node, and retrieves information from the file system view table corresponding to the expanded alternate entry. Thereafter, the node receives the retrieved information.

### BRIEF DESCRIPTION OF THE DRAWINGS

The accompanying drawings are incorporated in and constitute a part of this specification and, together with the description, explain the features and principles of the invention. In the drawings:

FIG. 1 is a diagram of an exemplary network environment in which features and aspects consistent with the present invention may be implemented;

FIG. 2 is a diagram of a device in which the features and aspects of the present invention may be implemented;

FIGS. 3A and 3B are a diagram of an exemplary flowchart of a method for passive filename translation in a manner consistent with the present invention; and

FIG. 4 is an example of a file system view table consistent with the present invention.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Overview

Methods and systems consistent with the principles of the invention enable passive filename translation based on process context. A system for accessing file system entities consistent with the principles of the present invention includes at least one node (e.g., process). A secondary storage has a plurality of file system entities with each of the file system entities having an entity name. The system for accessing file system entities may also include a file system view table with a plurality of entries and a lookup routine. The lookup routine receives a request from a node to access a file system entity. After determining that the file system view table does not have a first entry that corresponds to the file system entity, the lookup routine searches the file system view table for an alternate entry. The alternate entry comprises an entity name of the requested file system entity extended by an uncommon string of characters including an expandable sequence. The lookup routine then expands the expandable sequence of the alternate entry by a value corresponding to the node, and retrieves information from the file system view table corresponding to the expanded alternate entry.

### Network Environment

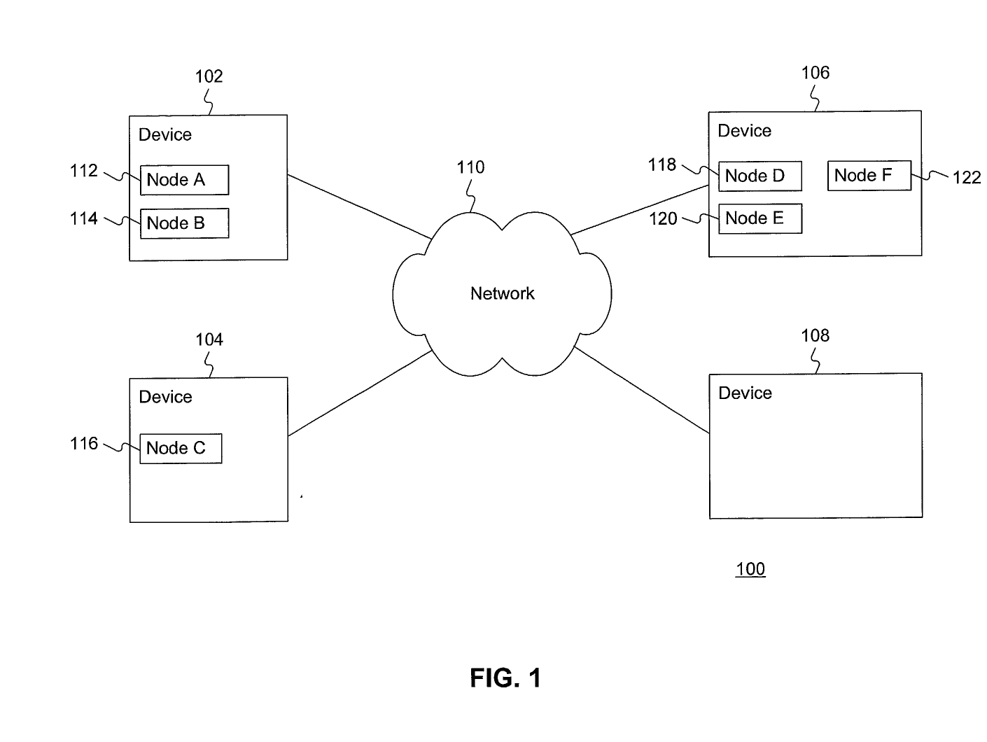

FIG. 1 is a diagram of an exemplary network environment in which features and aspects consistent with the present invention may be implemented. Network environment 100 comprises a number of devices, such as computers 102-108, connected to a network, such as network 110 (which may comprise a wired or wireless communication network, including the Internet). The components of FIG. 1 may be implemented through hardware, software, and/or firmware. The number of components in network environment 100 is not limited to what is shown.

Computers 102, 104, and 106 contain nodes that may communicate with each other. These nodes 112, 114, 116, and 118 maybe communicative entities, such as processes, running within a particular device and are able to communicate among themselves as well as access the resources of the computers 102-108. Nodes may be implemented by computer programs.

For example, nodes 112-118 may each access files or folders stored in its own computer (102, 104, and 106, respectively) or in a device remote with respect to each node. Different nodes may each have access to different view(s) of files and folders dependent on the current context of the node when attempting to view the files or folders. For example, suppose there is a computer with two network interfaces, one interface within a protected company network and the other within a public network. The computer also includes a mechanism that provides nodes with the ability to bind to one of the two network interfaces so that after the binding the process may only receive information from and send information to the one interface it is bound to. Configuration files must then provide different information to different nodes depending on which interface they are bound to. Systems and methods consistent with the present invention may enable different information to be provided to different processes depending on the interface even though the nodes refer to the same file system entity name.

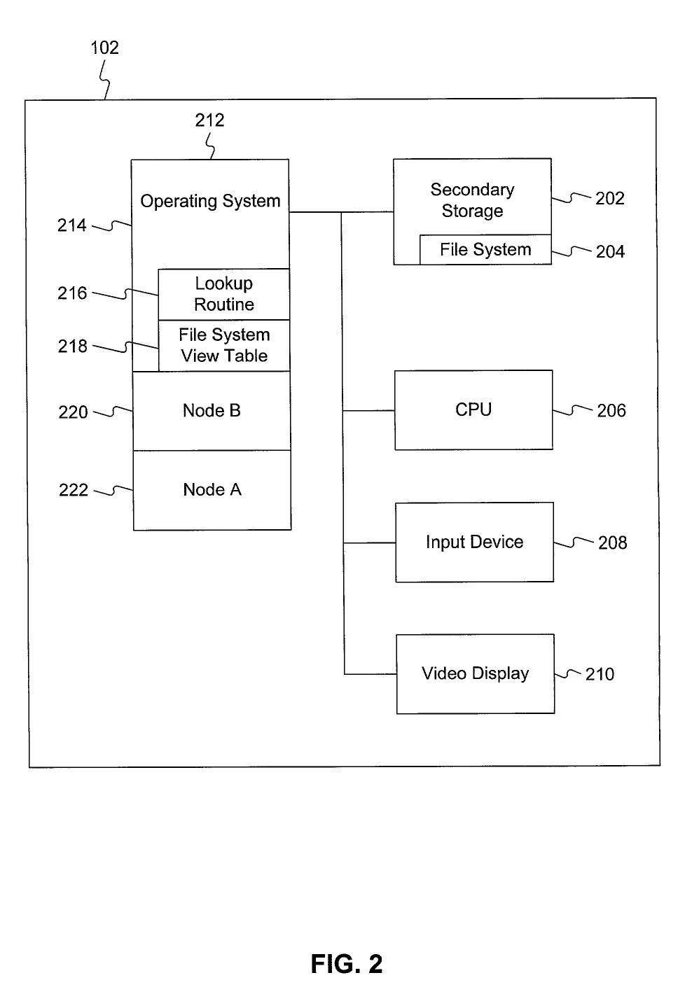

FIG. 2 is a diagram of computer 102 in greater detail, although computers 104, 106, and 108 may contain similar components. Computer 102 includes secondary storage 202, a central processing unit (CPU) 206, an input device 208, a video display 210, and a memory 212. One skilled in the art will appreciate that computer 102 may contain additional or different components.

Secondary storage 202 includes a file system 204, which comprises files, directories, and other related information needed to locate and access these items. These files, directories, and related information may be accessed by various nodes in the network. CPU 206 is capable of running in at least a user mode and a kernel mode. When CPU 206 executes programs running in user mode, it prevents the programs from directly manipulating or modifying the configuration of hardware components, such as video display 210. On the other hand, when CPU 206 executes programs running in the kernel mode, it allows such programs to directly manipulate the hardware components. The kernel mode may also be responsible for managing memory and files, allocating system resources, maintaining the time and date, launching applications, and various other system functions.

Memory 212 includes operating system 214, node B 220, and node A 222. Operating system 214 comprises at least lookup routine 216 and file system view table 218. Operating system 214 may be, for example, a UNIX operating system, Windows operating system, or other operating system for controlling device operations. Node B 220 and node A 222 correspond to node B 114 and node A 112 from FIG. 1.

Lookup routine 216 provides a requesting node with access to a file system entity in file system 204 by accessing file system view table 218 and first checking for the existence of an entry that corresponds to the entity desired to be accessed. Lookup routine 216 also checks the validity of the pathname components leading to the entry, and makes sure that appropriate authorization to access the file system entity exists. If the lookup succeeds, the routine may return information corresponding to the entity in question.

File system view table 218 may provide mappings to all the storage devices in a network environment. Thus, lookup routine 216 may operate on file system entities located anywhere in the network environment, not just in file system 204. Alternatively, file system view table 218 may provide mappings to only the storage devices in its own device, i.e. computer 102 in FIGS. 1 and 2.

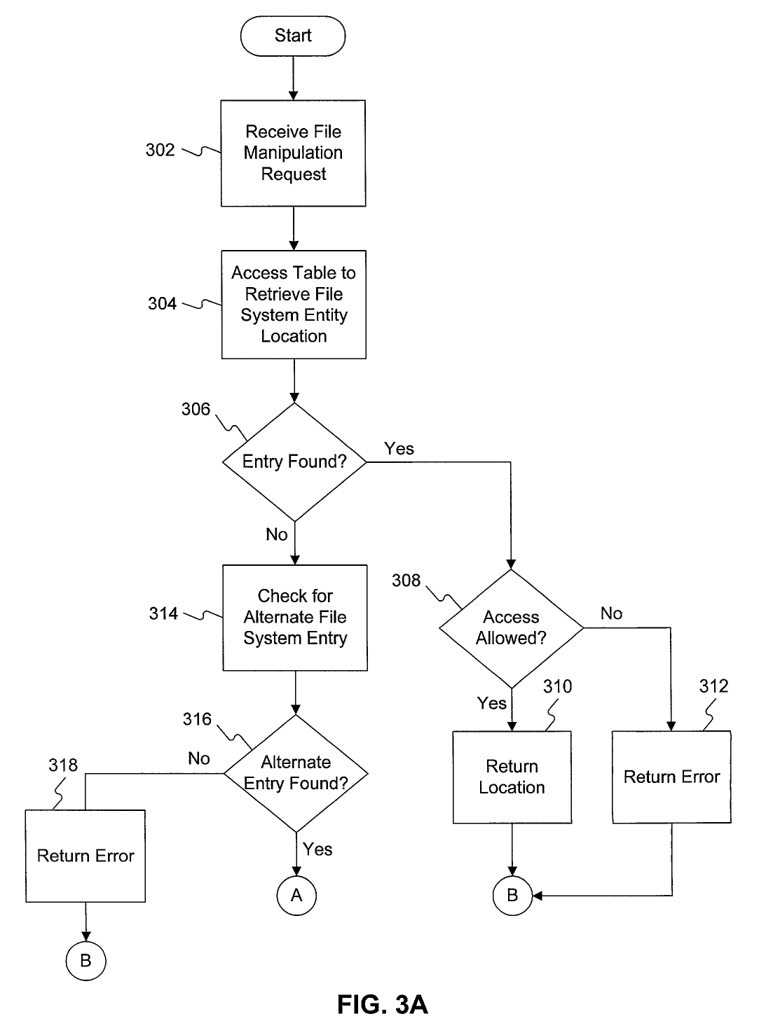

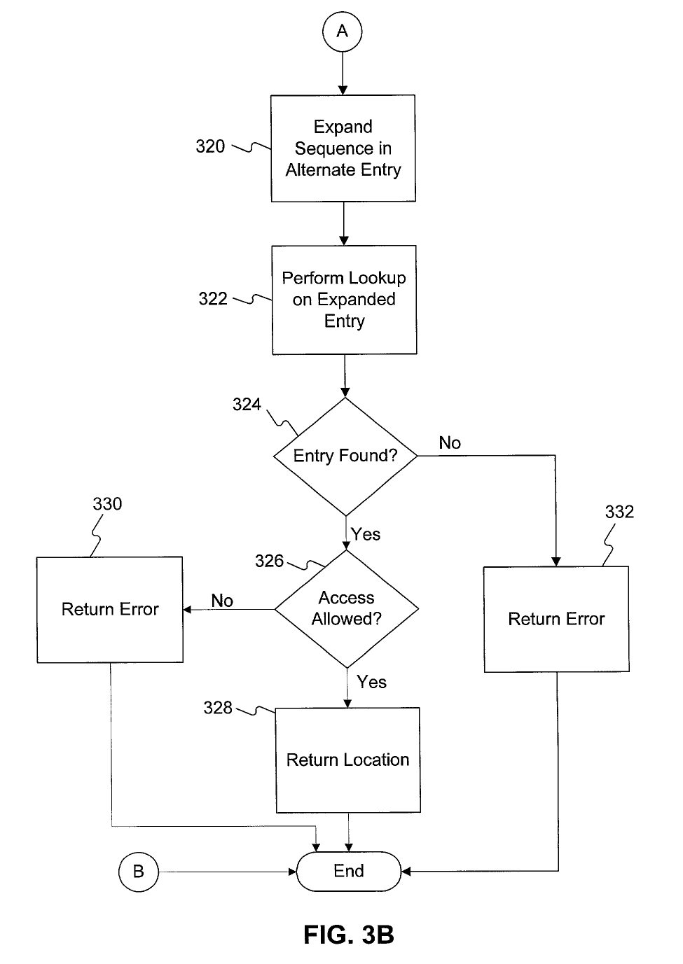

FIG. 3 is an exemplary flowchart of a method for passive filename translation performed by a lookup routine in a manner consistent with the present invention. Although the steps of the flow chart are described in a particular order, one skilled in the art will appreciate that these steps may be performed in a different order, or that some of these steps may be concurrent.

First, a lookup routine, such as lookup routine 216, receives a request from a node to open, create, or otherwise access a file system entity, such as a file, folder, or other entry in the file system (step 302). The request from the node includes an entity name, such as a directory name or a file name. Upon receiving the request from the node, the lookup routine accesses a file system view table, such as file system view table 218, to retrieve the location of the requested file system entity (step 304). Specifically, the lookup routine may use the entity name received with the request and attempt to map it to a network location using the file system view table.

The lookup routine then determines whether there is an entry in the file system view table corresponding to the entity name (step 306). If an entry corresponding to the entity name exists, then the lookup routine determines whether the requesting node is allowed to access the entry (step 308). For example, the lookup routine may check the validity of all pathname components leading to the entry. In addition, the lookup routine makes sure that the requesting node has authorization to access the entry. If access to the entry is not permitted, then the lookup routine returns an appropriate error indication to the requesting node (step 312). If access to the entry is permitted, then the lookup routine returns the location contained in the entry to the requesting node (step 310).

Upon receiving the location of the file system entity, the requesting node is able to access the file system. In one embodiment, the location is returned to the requesting node as part of an information node data structure (referred to herein as an “inode”), which stores various information about the file system entity. An mode is a data structure that holds information about files in a file system, such as the Unix file system. There may be an inode for each folder or file (or other file system entity), and a folder or file may be uniquely identified by the file system on which it resides and its inode number on that system. A folder may include a list of names (directory entities) and the inodes associated with them. An inode may include information such as the device where the mode resides, locking information, mode and type of file, the number of links to the file, user and group IDs, the number of bytes in the file, access and modification times, the time the inode itself was last modified, and the address of the file's blocks on disk. One of ordinary skill in the art will appreciate that an inode may include either less or more information than specified above.

When the lookup routine determines that an entry corresponding to the entity name does not exist, it checks the file system view table or a folder for an alternate file system entry (step 314). For example, the lookup routine may search for the same entity name extended by an uncommon string of characters, such as “\hat{ }A % user-% interface\hat{ }A”. Searching for the alternate entry may be implemented using a simple lookup in the file system view table or by parsing the contents (e.g., entity names) of a folder that may contain the file system entity. Also, the search may be for one or more alternate entries. For example, if the lookup routine expands the entity name with a first uncommon string and no corresponding entry is found, the lookup routine may subsequently expand the entity name with a second uncommon string, and so on.

The uncommon string may contain arbitrarily ordered expandable sequences with predefined meanings, such as % user and % interface in the example above. As such, these expandable sequences may be representative of the context of the requesting node. Context generally refers to a framework in which a node may be defined. For example, the user of a node and the interface to which a node is connected define a particular context of a node. Another factor that may further define the context of a node and thereby be used as the subject of an expandable sequence is time of day. Other factors that may define context include terminal (e.g., which serial line) to which a node is connected, access privileges for the node, program(s) assigned to the node, day of the week, date, or any other factors that may generally define time, environment, configuration, and location attributes assignable to a node.

Next, the lookup routine may determine whether an alternate entry exists (step 316). If no alternate entry exists, then the lookup routine returns an appropriate error indication to the requesting node (step 318). If an alternate entry exists in the file system view table, then the lookup routine proceeds to expand the expandable sequences in the alternate entry by their actual values (step 320). For example, suppose a file system entity with the name “entityname” is extended by the uncommon string of “\hat{ }A % user-% interface\hat{ }A”, so that the lookup routine searches for an alternate entry in the file system view table of “entityname\hat{ }A % user-% interface\hat{ }A”. After the lookup routine expands the expandable sequences by their actual values, the result may be “entityname\hat{ }A123-eth2\hat{ }A”, for a requesting node with a user identification of 123, and an assigned network interface of “eth2.”

Once the lookup routine completes the expansion of the expandable sequences, it performs a lookup in the file system view table on the expanded entry (step 322). The lookup routine then determines whether there is an entry in the file system view table corresponding to the expanded entry (step 324). The determination may occur by looking for an entry corresponding to the expanded entry in various permutations. For example, the lookup routine may first look for an entry that corresponds to “entityname\hat{ }A123-eth2\hat{ }A.” If such an entry is not found, the lookup routine may look for an entry that corresponds to “entityname\hat{ }A123\hat{ }A.” Then it may try “entityname\hat{ }Aeth2\hat{ }A,” and so on until several combinations have been tried. Alternatively, the lookup routine may look for an entry corresponding to the expanded entry without trying various permutations (e.g., no variations are searched after the initial lookup).

If no entry corresponding to the expanded entry exists, then the lookup routine returns an appropriate error indication to the requesting node (step 332). If an entry corresponding to the expanded entry exists in the file system view table, then the lookup routine determines whether the requesting node is allowed access (step 326). For example, the lookup routine may check the validity of all pathname components leading to the entry corresponding to the expanded entry. In addition, the lookup routine makes sure that the requesting node has authorization to access this entry. If access to the entry corresponding to the expanded entry is not permitted, then the lookup routine returns an appropriate error indication to the requesting node (step 330). If access to the entry corresponding to the expanded entry is permitted, then the lookup routine returns the location contained in the entry corresponding to the expanded entry to the requesting node (step 328). Upon receiving the location of the file system entity, the requesting node is able to access the file system. In one embodiment, the location is returned to the requesting node as part of an information node (inode) or other similar data structure.

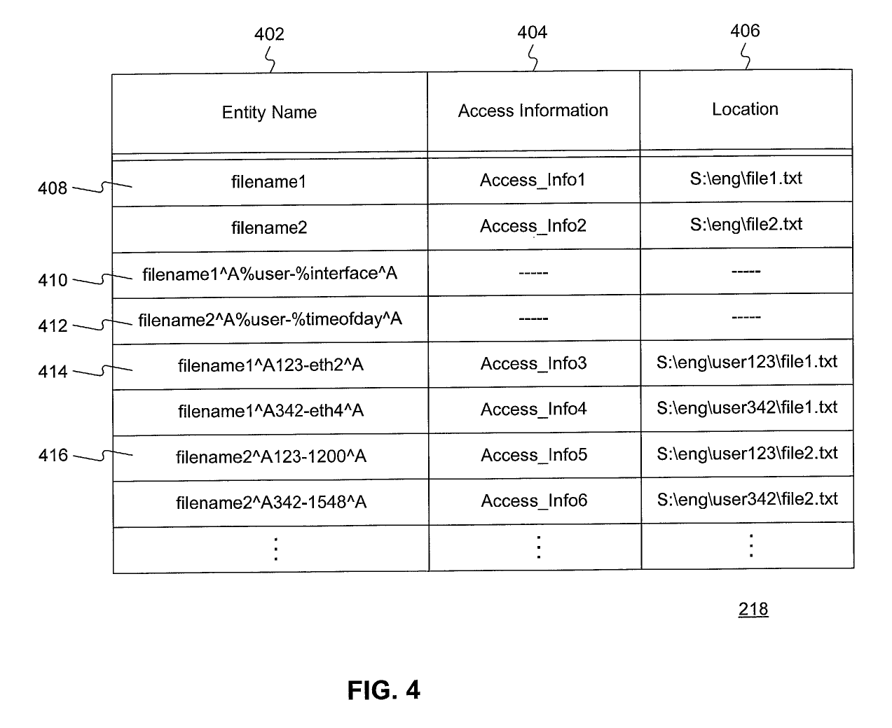

FIG. 4 shows an example of file system view table 218 consistent with the present invention. File system view table 218 has three columns: the entity name 402, indicating the name that nodes use to refer to the corresponding file system entity; the access information 404, indicating information for use in determining whether a node is permitted access to a file system entity; and the location 406, indicating the network location (e.g., a UNIX node) of the file system entity.

There are several different types of entries under the entity name column 402. Entry 408 contains the entity name of “filename1”. Entries 410 and 412, on the other hand, are alternate entries comprising entity names that have been extended by an uncommon string. Specifically, entry 410 contains the entity name “filename1\hat{ }A % user-% interface\hat{ }A”, which the lookup routine may search for after an initial lookup failed due to a missing file system entry. Entry 410 includes the expandable sequences of “% user” and “% interface”. Entry 412 contains an extended entity that includes the expandable sequences of “% user” and “% timeofday”. One of ordinary skill in the art will appreciate that other expandable sequences may be used dependent on the particular desired context of the requesting node.

Entries 414 and 416 are entries that correspond to entries 410 and 412, respectively, with actual values substituted for the expandable sequences. Accordingly, a lookup routine that performed a search for an alternate file system entry, such as entry 410, may expand the expandable sequences in entry 410. In the case that the requesting node has a user identification of 123 and assigned network interface of eth2, the lookup routine subsequently performs a lookup on “filename1\hat{ }A123-eth2\hat{ }A” and finds entry 414. The lookup routine makes sure that the requesting node may access the corresponding file system entity with the aid of access_info3. Assuming that access is permitted, the lookup routine returns a location of “S:\eng\user123\file1.txt” to the requesting node. One of ordinary skill in the art will appreciate that a file system view table may include more or less rows and/or columns than depicted above. For example, a file system view table may not include a column of access information.

While the present invention has been described in connection with various embodiments, many modifications will be readily apparent to those skilled in the art. For example, an extension of translating file and folder names is translating file content. Expandable sequences may be placed in a file so that the content of the file may differ dependent on context.

Although aspects of the present invention are described as being stored in memory, one skilled in the art will appreciate that these aspects can also be stored on or read from other types of computer-readable media, such as secondary storage devices, like hard disks, floppy disks, or CD-ROM; a carrier wave, optical signal or digital signal from a network, such as the Internet; or other forms of RAM or ROM either currently known or later developed. Additionally, although a number of the software components are described as being located on the same machine, one skilled in the art will appreciate that these components may be distributed over a number of machines. The invention, therefore, is not limited to the disclosure herein, but is intended to cover any adaptations or variations thereof.

What is claimed is:

1. A method for accessing file system entities, comprising:
receiving a request from a node to access a file system entity having an entity name;
searching for an alternate entry corresponding to the file system entity, the alternate entry comprising the entity name extended by an expandable sequence;
expanding the expandable sequence by a value corresponding to the node; and
retrieving information corresponding to the expanded sequence.

2. The method of claim 1, wherein the retrieved information includes a location of the file system entity.

3. The method of claim 1, wherein the retrieved information comprises an information node.

4. The method of claim 1, said retrieving comprising:
looking up the information in a system view table using the expanded sequence; and
returning the information to the node.

5. The method of claim 1, wherein the node comprises a process.

6. The method of claim 1, wherein the file system entity is at least one of a file and a folder.

7. The method of claim 1, wherein the value is representative of a context of the node.

8. The method of claim 7, wherein the context is one of user identification, network interface, and time of day.

9. The method of claim 4, said searching comprising:
looking up the alternate entry in the file system view table based on a determination that the system view table is missing a first entry corresponding to the file system entity.

10. The method of claim 9, further comprising:
sending information corresponding to the first entry to the node based on a determination that the file system view table has the first entry.

11. A method for accessing file system entities, comprising:
receiving a request from a node to access a file system entity having an entity name;
determining whether a file system view table has a first entry corresponding to the file system entity;
searching the file system view table for an alternate entry based on the determination, the alternate entry comprising the entity name extended by an uncommon string of characters including an expandable sequence;
expanding the expandable sequence of the alternate entry by a value corresponding to the node; and
retrieving information corresponding to the expanded alternate entry.

12. The method of claim 11, said retrieving comprising:
looking up the information in the file system view table using the expanded alternate entry; and
returning the information to the node.

13. The method of claim 11, said searching comprising:
looking up the alternate entry in the file system view table based on a determination that the system view table is missing the first entry.

14. The method of claim 13, further comprising:
sending information corresponding to the first entry to the node based on a determination that the file system view table has the first entry.

15. The method of claim 12, said returning comprising:
sending the information to the node based on a determination that the node is permitted access to the information; and
sending an error indication to the node based on a determination that the node is not permitted access to the information.

16. The method of claim 11, further comprising:
sending an error indication to the node based on a determination that the file system view table is missing the alternate entry.

17. The method of claim 12, further comprising:
sending an error indication to the node based on a determination that the file system view table is missing the information corresponding to the expanded alternate entry.

18. An apparatus for accessing file system entities, comprising:
a memory including an operating system that: receives a request from a node to access a file system entity having an entity name; searches for an alternate entry corresponding to the file system entity, the alternate entry comprising the entity name extended by an uncommon string of characters including an expandable sequence; expands the expandable sequence of the alternate entry by a value corresponding to the node; and retrieves information corresponding to the expanded alternate entry; and
a processor that runs the operating system.

19. An apparatus for accessing file system entities, comprising:
means for receiving a request from a node to access a file system entity having an entity name;
means for searching for an alternate entry corresponding to the file system entity, the alternate entry comprising the entity name extended by an uncommon string of characters including an expandable sequence;
means for expanding the expandable sequence of the alternate entry by a value corresponding to the node; and
means for retrieving information corresponding to the expanded alternate entry.

20. The apparatus of claim 19, wherein the retrieved information includes a location of the file system entity.

21. The apparatus of claim 19, wherein the retrieved information comprises an information node.

22. The apparatus of claim 19, said means for retrieving comprising:
means for looking up the information in a system view table using the expanded alternate entry; and
means for returning the information to the node.

23. The apparatus of claim 19, wherein the node comprises a process.

24. The apparatus of claim 19, wherein the file system entity is at least one of a file and a folder.

25. The apparatus of claim 19, wherein the value is representative of a context of the node.

26. The apparatus of claim 25, wherein the context is one of user identification, network interface, and time of day.

27. The apparatus of claim 22, said means for searching comprising:
means for looking up the alternate entry in the file system view table based on a determination that the system view table is missing a first entry corresponding to the file system entity.

28. The apparatus of claim 27, further comprising:
means for sending information corresponding to the first entry to the node based on a determination that the file system view table has the first entry.

29. A computer-readable medium containing instructions for causing a computer to perform a method to facilitate access to file system entities, the method comprising:
receiving a request from a node to access a file system entity having an entity name;
searching for an alternate entry corresponding to the file system entity, the alternate entry comprising the entity name extended by an uncommon string of characters including an expandable sequence;
expanding the expandable sequence of the alternate entry by a value corresponding to the node; and
retrieving information corresponding to the expanded alternate entry.

30. The computer-readable medium of claim 29, wherein the retrieved information includes a location of the file system entity.

31. The computer-readable medium of claim 29, wherein the retrieved information comprises an information node.

32. The computer-readable medium of claim 29, said retrieving comprising:
looking up the information in a system view table using the expanded alternate entry; and
returning the information to the node.

33. The computer-readable medium of claim 29, wherein the node comprises a process.

34. The computer-readable medium of claim 29, wherein the file system entity is at least one of a file and a folder.

35. The computer-readable medium of claim 29, wherein the value is representative of a context of the node.

36. The computer-readable medium of claim 35, wherein the context is one of user identification, network interface, and time of day.

37. The computer-readable medium of claim 32, said searching comprising:
looking up the alternate entry in the file system view table based on a determination that the system view table is missing a first entry corresponding to the file system entity.

38. The computer-readable medium of claim 37, further comprising:
sending information corresponding to the first entry to the node based on a determination that the file system view table has the first entry.

39. A computer-readable memory device encoded with a data structure for use by an operating system in accessing file system entities, the data structure comprising:
a first entry comprising an entity name extended by an uncommon string of characters including an expandable sequence; and
a second entry comprising the entity name extended by an uncommon string of characters including a value representative of a context of a node.

40. An apparatus for accessing file system entities, comprising:
a secondary storage comprising a plurality of file system entities, each of the file system entities including an entity name;
a memory comprising:
an operating system including:
a file system view table including a plurality of entries;
a lookup routine operable to receive a request from a node to access a file system entity; determine whether the file system view table has a first entry corresponding to the file system entity; search the file system view table for an alternate entry based on the determination, the alternate entry comprising an entity name of the requested entity extended by an uncommon string of characters including an expandable sequence; expand the expandable sequence of the alternate entry by a value corresponding to the node; and retrieve information corresponding to the expanded alternate entry; and
a processor that runs the operating system.

41. A distributed system with a network having devices with nodes for accessing file system entities, one of the devices comprising:
a secondary storage comprising a plurality of file system entities, each of the file system entities including an entity name;
a memory comprising:
an operating system including:
a file system view table including a plurality of entries;
a lookup routine operable to receive a request from a node to access a file system entity; determine whether the file system view table has a first entry corresponding to the file system entity; search the file system view table for an alternate entry based on the determination, the alternate entry comprising an entity name of the requested entity extended by an uncommon string of characters including an expandable sequence; expand the expandable sequence of the alternate entry by a value corresponding to the node; and retrieve information corresponding to the expanded alternate entry; and
a processor that runs the operating system.

42. A method for accessing file system entities, comprising:
sending, to a lookup routine, a request for access to a file system entity having an entity name, wherein the lookup routine performs a method comprising:
searching for an alternate entry corresponding to the file system entity, the alternate entry comprising the entity name extended by an uncommon string of characters including an expandable sequence;
expanding the expandable sequence of the alternate entry by a value corresponding to the node; and
retrieving information corresponding to the expanded alternate entry; and
receiving the retrieved information.

43. The method of claim 42, said retrieving comprising:
looking up the information in a system view table using the expanded alternate entry in various permutations.
